(19) United States
(12) Patent Application Publication
(10) Pub. No.: US 2010/0011039 A1
(43) Pub. Date: Jan. 14, 2010

(54) Device and method for solving a system of equations

(76) Inventor: James Vannucci, McDonald, PA (US)

Correspondence Address: James Vannucci, 5212 Forest View Drive, McDonald, PA, 15057, US

(21) Appl. No.: 12/218,052

(22) Filed: Jul. 11, 2008

(51) Int. Cl. G06F 17/11; G06F 17/14; G06F 17/16

(52) U.S. Cl. 708/400; 708/607; 708/650

(57) ABSTRACT

A system of equations with a Toeplitz coefficient matrix [T] can be efficiently solved by approximating the coefficient matrix [T] with an approximately Toeplitz coefficient matrix [Tₐₚₚ] that can be efficiently transformed to a banded form. The system of equations with the banded coefficient matrix is then efficiently solved and this solution is used to obtain the solution to the original system of equations with the Toeplitz coefficient matrix [T].

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A COMPUTER PROGRAM LISTING COMPACT DISC APPENDIX

Not applicable.

### BACKGROUND OF THE INVENTION

The present invention concerns solving a set of equations with a Toeplitz coefficient matrix [T]. Toeplitz matrices have constant entries along their diagonal elements. Toeplitz and approximately Toeplitz matrices frequently appear in the methods of many imaging, communications and sensing devices.

Substituting a Toeplitz matrix for an approximately Toeplitz matrix, and vice versa, is well known in the prior art. Many applications involve the use of approximately Toeplitz matrices instead of Toeplitz matrices. In many of these applications a Toeplitz matrix may be substituted for an approximately Toeplitz matrix without a significant effect on the solution, or with only a relatively small number of extra calculations required to obtain a satisfactory solution.

Replacing all the elements along a diagonal of an approximately Toeplitz matrix with the average of the elements along that diagonal results in a good approximate solution for many problems. Jansson et al. (U.S. Pat. No. 5,153,926) and Ding (2006/0039458 A1). Barnard (U.S. Pat. No. 6,545,639) discloses replacing a covariance matrix in a radar/sonar sensor array system with a Toeplitz matrix whose elements along a diagonal are the least squares approximation of the elements along a diagonal of the covariance matrix. Hui (US 2005/0276356) discloses iteratively calculating the inverse of an approximately Toeplitz matrix from the inverse of a Toeplitz matrix.

Many methods already exist for solving a Toeplitz system of equations. These methods are extensively documented in the prior art and so will only be very briefly summarized here. These methods can generally be classified as either direct or iterative methods with the direct methods being further sub classified as classical, fast or super fast depending on the number of steps required for a solution of the system of equations they represent.

The most popular iterative methods include methods from the conjugate gradient family of methods. Classical direct methods require O(n³) computational steps and include Gauss elimination and Cholesky decomposition. The classical direct methods do not take advantage of the displacement structure of the matrices. Fast direct methods take advantage of the displacement structure of matrices and require O(n²) steps. Examples of these methods include the Levinson type methods, and the Schur type methods. Super fast direct methods are relatively new and require O(n(log n)²) steps.

Iterative methods can be fast and stable, but can also be slow to converge for some systems. The classical direct methods are stable, but are slow. The fast direct methods are stable and fast. The super fast direct methods have not been shown to be stable and many are only asymptotically super fast. None of the direct and iterative methods can be easily implemented on parallel computer architectures with substantial computational benefits. As such, there is a need for stable methods that give superior performance and that can be easily implemented on parallel architectures.

### BRIEF SUMMARY OF THE INVENTION

Certain approximately Toeplitz matrices [Tₐₚₚ] can be transformed into a banded form. A system of equations with a Toeplitz coefficient matrix [T] can be efficiently solved by substituting an approximately Toeplitz matrix [Tₐₚₚ] for the Toeplitz coefficient matrix [T]. The solution to the system of equations with the Toeplitz coefficient matrix is obtained from the solution to the system of equations with this approximately Toeplitz matrix. To improve the accuracy of the approximation, rows and columns of the Toeplitz coefficient matrix [T] can be modified and the Toeplitz coefficient matrix [T] can be extended to a larger dimension.

### BRIEF DESCRIPTION OF SEVERAL VIEWS OF THE DRAWING

FIG. 1 shows the system of equations with pad and modified rows and columns.

FIGS. 2(a) and 2(b) show the components for the application of the disclosed invention.

### DETAILED DESCRIPTION OF THE INVENTION

A system of equations with a Toeplitz coefficient matrix [T], known vector [Y] and unknown solution vector [X] takes the following form.

[T][X]=[Y]

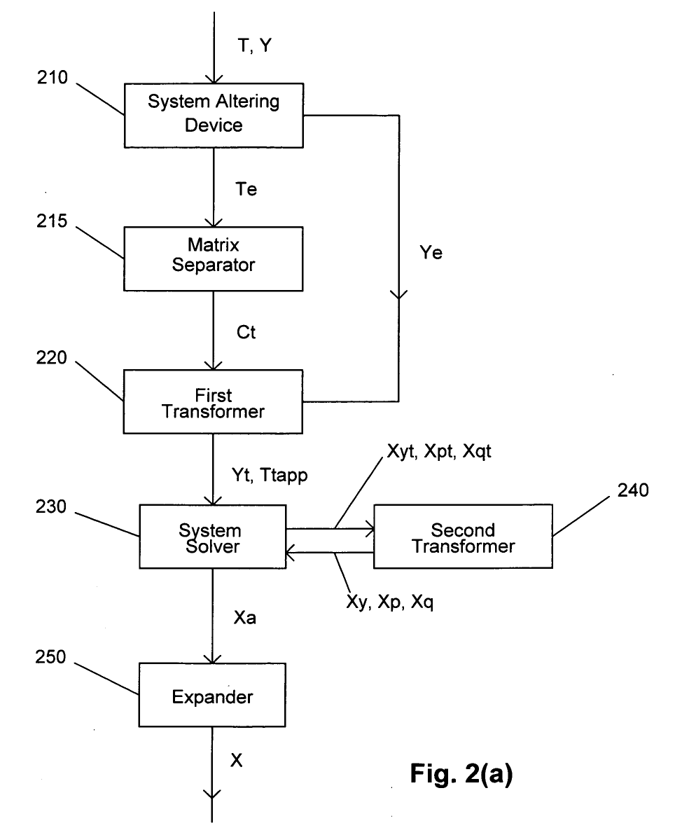

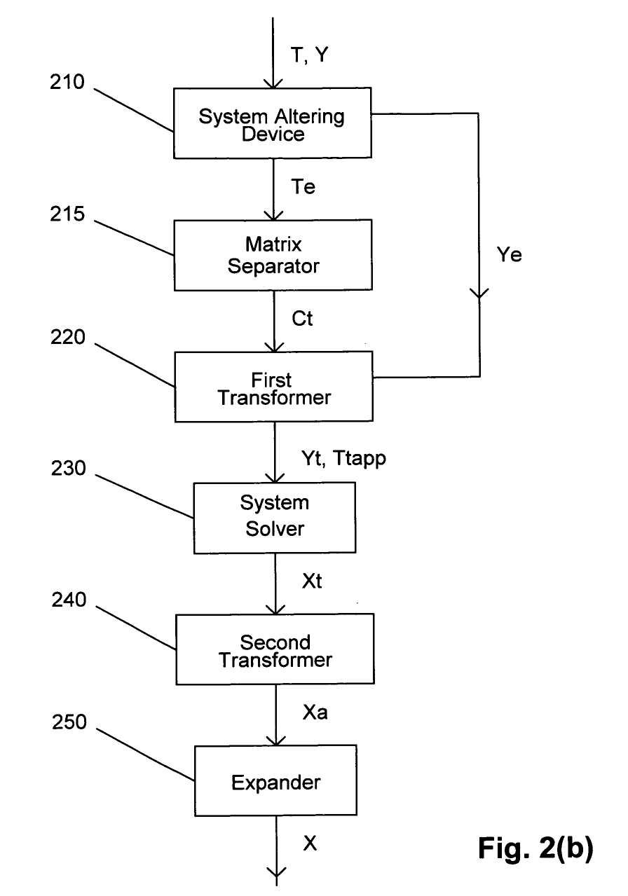

The matrix [T] can be altered to improve the solution characteristics of the system of equations. These alterations are performed by a system altering device 210 and include forming an extended Toeplitz coefficient matrix, [Tₑ], of greater dimensions by extending the diagonals of the matrix [T]. FIGS. 2(a) and 2(b). Extending a matrix [T] to a matrix [Tₑ] introduces additional unknowns, [Sₚ]. The matrix [T] is extended by placing rows and columns around the matrix [T]. These rows and columns are called pad rows and columns.

[Tₑ][Xₑ]=[Yₑ]+[Aₚ][Sₚ]

The [Yₑ] and [Xₑ] vectors are the [Y] and [X] vectors with a zero pad usually at the top and bottom of the vectors. The system altering device 210 inserts the zero values into the [Y] and [X] vectors and forms the matrix [Aₚ] which contains columns that only have nonzero values for elements that correspond to pad rows.

A matrix [T] or matrix [Tₑ] can be separated into the sum of a circulant matrix [gₛ] and a matrix [gₐ]. The matrix [gₐ] is a Toeplitz matrix that becomes circulant when elements below the principal diagonal are each multiplied by negative one.

([gₛ]+[gₐ])[Xₑ]=[Yₑ]+[Aₚ][Sₚ]

This equation is domain doubled to form a square coefficient matrix with dimensions of at least (2n−2)×(2n−2), where the original dimensions of the system of equations are n×n. A negative one is factored out from the upper right and lower left quadrants of the matrices [gₐ].

$$\vert \begin{matrix}[ {g}_{s} + {g}_{a} ] & [ {g}_{s} - ( - {g}_{a} ) ] \\ [ {g}_{s} - ( - {g}_{a} ) ] & [ {g}_{s} + {g}_{a} ]\end{matrix} \vert \vert \begin{matrix}{X}_{e} \\ 0\end{matrix} \vert = \vert \begin{matrix}{Y}_{e} \\ {Y}_{e}\end{matrix} \vert + \vert \begin{matrix}{A}_{p} \\ {A}_{p}\end{matrix} \vert \vert {S}_{p} \vert$$

The domain doubled coefficient matrix is then factored into terms comprising circulant matrices [Gₛ] and [Gₐ], and diagonal matrices [II]. The elements of the matrix [II] have a value of one in the upper half of the matrix, and a value of minus one in the lower half of the matrix.

([Gₛ]+[II][Gₐ][II])[Xₑ/0]=[Yₑ/Yₑ]+[Aₚ/Aₚ][Sₚ]

This system of equations can be Fourier transformed by a discrete Fourier transform to form a domain doubled transformed system of equations.

([Gₛₜ]+[IIₜ][Gₐₜ][IIₜ])[(Xₑ/0)ₜ]=[(Yₑ/Yₑ)ₜ]+[(Aₚ/Aₚ)ₜ][Sₚ]

Approximately half of the elements in the matrices and vectors of this domain doubled transformed system of equations are zero. If the zero elements are eliminated, the dimensions of this system of equations are reduced to n×n. The solution vector [X] can be determined from the following equation.

([Cₛₜ]+[D₁ₜ][Cₐₜ][D₂ₜ])[Xₜ]=[Yₜ]+[Aₚₜ][Sₚ]

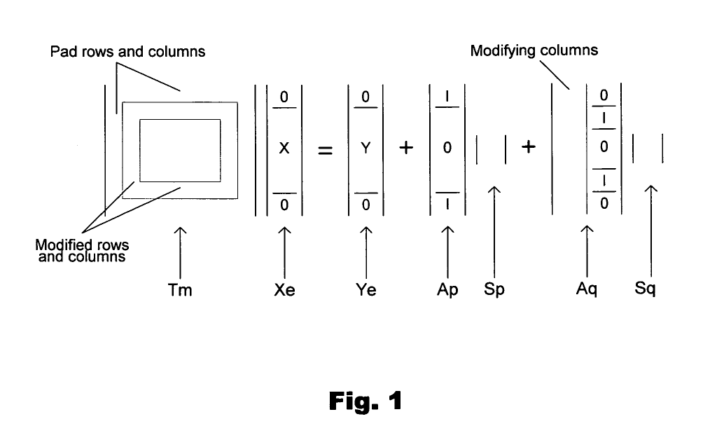

The matrices [Cₛₜ] and [Cₐₜ] are diagonal matrices. The [Dₜ] matrices are circulant. This system of equations can be reverse transformed by taking the reverse Fourier transform of the system of equations to obtain a system of equations with a separated coefficient matrix. FIG. 1.

([Cₛ]+[D₁][Cₐ][D₂])[Xₑ]=[Yₑ]+[Aₚ][Sₚ]

([Cₛ]+[D₁][Cₐ][D₂])[Xₑ]=[Tₑ]

A matrix separator 215 determines the elements in the [Cₛ] and [Cₐ] matrices by solving the equations that constitute this expression. A quotient of a diagonal matrix [U] divided by a diagonal matrix [L] can be approximately substituted for each of the [D] matrices in the above equation. This results in an approximately Toeplitz matrix [Tₐₚₚ] being formed.

[Tₐₚₚ]=[Cₛ]+([U₁]/[L₁])[Cₐ]([U₂]/[L₂])

The matrices [L₁] and [L₂] can be equal. This system of equations can be transformed by a first transformer 220 as follows.

[Tₜₐₚₚ]=[FFT][L₁][Tₐₚₚ][L₂][iFFT]

[Tₜₐₚₚ]=[FFT][L₁][Cₛ][L₂][iFFT]+[FFT][U₁][Cₐ][U₂][iFFT]

The Fourier transforms of the [L] and [U] matrices, [Lₜ] and [Uₜ], are banded. The resulting matrix [Tₜₐₚₚ] is narrow banded.

[Tₜₐₚₚ]=[L₁ₜ][Cₛₜ][L₂ₜ]+[U₁ₜ][Cₐₜ][U₂ₜ]

The matrix [FFT] is the fast Fourier transform, the matrix [iFFT] is the inverse fast Fourier transform. The desired forms for the transformed [L] and [U] matrices are obtained if the elements on the principal diagonals of the matrices [U] and [L] are given by the following expressions. The summation is over the index m. The range of m is arbitrary.

[U]=ΣAₘ sin(wₘx)+ΣCₘ cos(wₘx)

[L]=ΣBₘ cos(wₘx)+ΣDₘ sin(wₘx)

The transformed system of equations with the transformed approximately Toeplitz matrix [Tₜₐₚₚ] takes the following form. A matrix [iL] is the inverse of a matrix [L]. The first transformer 220 performs calculations that comprise calculating the matrix [Tₜₐₚₚ] and the transformed vector [Yₜ] resulting in the following expressions.

([L₁ₜ][Cₛₜ][L₂ₜ]+[U₁ₜ][Cₐₜ][U₂ₜ])[Xₜ]=[Yₜ]+[Aₚₜ][Sₚ]

[Xₜ]=[FFT][iL₂][Xₑ]

[Yₜ]=[FFT][L₁][Yₑ]

The system altering device 210 can modify a [Tₐₚₚ] matrix by adding modifying rows and columns to already existing rows and columns of the [Tₐₚₚ] matrix. Modifying a [Tₐₚₚ] matrix introduces additional unknowns, [S_{q}], to the system of equations. A modified matrix [Tₘ] can be formed from a [Tₐₚₚ] matrix and the product of two matrices [B_{q}] and [A_{q}].

[Tₐₚₚ][Xₑ]=[Yₑ]+[Aₚ][Sₚ]

[Tₐₚₚ]=[Tₘ]−[A_{q}][B_{q}]

[B_{q}][Xₑ]=[S_{q}]

These equations can be used to calculate the matrix [Tₘ] once matrices [A_{q}] and [B_{q}] have been selected. The system of equations takes the following form. FIG. 1. The matrix [B_{q}] comprises modifying rows and rows with all zero elements except for elements corresponding to modifying columns. The matrix [Aₚ] comprises columns with all zero elements except for elements corresponding to pad rows of the [Tₑ] matrix. The matrix [Bₚ] comprises pad rows of the [Tₑ] matrix.

[Tₘ][Xₑ]=[Yₑ]+[A_{q}][S_{q}]+[Aₚ][Sₚ]

The matrix [A_{q}] contains nonzero values for elements corresponding to modified rows, and modifying columns added to the [Tₑ] matrix. The matrix separator 215, calculates the [Cₛ] and [Cₐ] matrices, and the transformed matrices [Cₛₜ] and [Cₐₜ] by calculating the product of a FFT with the first column of the [Cₛ] and [Cₐ] matrices. FIGS. 2(a) and 2(b).

The Aₘ, Bₘ, Cₘ and Dₘ weight coefficients can be determined by using a matrix quotient [U]/[L] to model the principal diagonal of each of the [D] matrix. The function f(n) designates the n^{th} element on the diagonal of a [D] matrix. Usually it is desirable to express the [U] and [L] matrices with the fewest number and lowest order of terms. Different [D] matrices usually have different f(n) functions.

An iterative weighted least squares algorithm can be used to determine the magnitude of the weight coefficients. This approach results in an error distribution between the quotient [U]/[L] and the function f(n) that has most of the error occur in a small range of values for n, when n is small. This permits the rows and columns associated with the small values of n to be modified or padded. Pad and modified rows and columns remove the error. The weight coefficients can be iteratively updated with the following expression. The outer summation is over n, the number of elements in the [D] matrices. The inner summations are over m.

$${\sum }_{n} {( f ( n ) ( {\sum }_{m} {D}_{m} sin ( {w}_{m} n ) + {\sum }_{m} {B}_{m} cos ( {w}_{m} n ) ) + \\ {\sum }_{m} {A}_{m} sin ( {w}_{m} n ) + {\sum }_{m} {C}_{m} cos ( {w}_{m} n ) )}^{2} / {B}_{p} ( n ) = err$$

Here Bp(n) is given by the following expression with the values of Dₘ and Bₘ being determined from the previous iteration.

$${B}_{p} ( n ) = {\sum }_{m} {D}_{m} sin ( {w}_{m} n ) + {\sum }_{m} {B}_{m} cos ( {w}_{m} n )$$

Other regression methods, including non-linear regression methods, can be used to determine the weight coefficients that minimize the magnitude of elements not included within specified bands of the transformed [U] and [L] matrices. These methods are well known in the art. The f(n) function can be approximately expanded as follows.

$$f ( n ) = \frac{{\sum }_{m} {A}_{m} sin ( {w}_{m} n ) + {\sum }_{m} {C}_{m} cos ( {w}_{m} n )}{{\sum }_{m} {D}_{m} sin ( {w}_{m} n ) + {\sum }_{m} {B}_{m} cos ( {w}_{m} n )} + err ( n )$$

From this equation, non linear regression analysis can be used to determine the values of Aₘ, Bₘ, Cₘ and Dₘ that give the desired distribution for err(n). The sum over the index m represents the sum over the expansion terms. Usually the fewest number of terms and lowest order terms are selected. The sum over the index n usually does not include values of f(n) that correspond to pad and modified rows and columns. After the weight coefficients have been determined, the pad and modified rows and columns can be calculated.

The system solver 230 can rearrange rows and columns of the matrix [Tₜₐₚₚ], rearrange the complex transformed vector [Yₜ] by factoring it into a form that has the magnitude of the real known values in its upper half and the magnitude of the imaginary knowns in its lower half, and shuffle these real known values and the imaginary known values into a final form for the transformed vector [Yₜ]. FIGS. 2(a) and 2(b). These steps can convert the [Tₜₐₚₚ] matrix from a multiple banded form to a single banded form.

The system solver 230 uses any methods known in the art for solving a systems of equations with a banded coefficient matrix to obtain a transformed solution vector [Xₜ]. These methods include, but are not limited to, Gauss elimination, methods that separate the banded transformed coefficient matrix into a product comprising an upper banded matrix and a lower banded matrix, and iterative methods including methods from the conjugate gradient family of methods. The system solver 230 also performs forward and backward substitution on a vector or column of a transformed component matrix [Aₜ].

The system solver 230 can change the value of elements in the bands of the matrix [Tₜₐₚₚ] for improved solution characteristics. Any changes to the matrix [Tₜₐₚₚ] introduce additional unknowns to the transformed system of equations. These unknowns are entries in the vector [S_{q}]. The transformed component matrix [A_{qt}] contains columns calculated from the matrix [Tₜₐₚₚ]. The matrix [B_{qt}] contains rows calculated from the matrix [Tₜₐₚₚ]. As a non-limiting example, if the system solver 230 uses methods that separate the [Tₜₐₚₚ] into a product of matrices that comprise a lower banded matrix, a diagonal matrix and an upper banded matrix, the smallest values in the diagonal matrix can be replaced with larger values. Each replaced value introduces an unknown into the system of equations. In this example, the matrix [A_{qt}] comprises columns calculated from the banded matrix to the left of the diagonal matrix and the matrix [B_{qt}] comprises rows calculated from the banded matrix to the right of the diagonal matrix. These rows and columns correspond to the replaced values in the diagonal matrix. The entries in the [S_{q}] vector that correspond to these rows and columns are determined in the same manner as the other entries in the [S_{q}] vector.

As a non-limiting example, the following system of equations comprises an ill conditioned matrix [T₀], a matrix [d], pad vector [Sₚ], modified vector [S_{q}], known vector [Y] and unknown vector [X]. The modifying rows and columns [A_{q}] and [B_{q}] are used to improve the conditioning of the coefficient matrix.

([Tₒ]+[d])[X]=[Y]+[Aₚ][Sₚ]

([T]+[d])[X]=[Y]+[Aₚ][Sₚ]+[A_{q}][S_{q}]

[X]=([I]−[T⁻¹][d]+−)[T⁻¹]([Y]+[Aₚ][Sₚ]+[A_{q}][S_{q}])

[B_{q}][X]=[S_{q}]

[Bₚ][X]=[Sₚ]

These equations can be used to calculated the [S] vectors. Once the [S] vectors have been determined, [X] can be calculated. The calculations required by these equations are performed by the system solver 230. These equations can also be calculated and solved in the transformed space.

The system solver 230 also uses the following equations to solve for unknown vectors [Sₚ] and [S_{q}]. The matrices [Aₚₜ] and [A_{qt}] are transformed component matrices. The system solver 230 also calculates the contributions from the [Aₚ][Sₚ] and [A_{q}][S_{q}] products or their transformed quantities and adds it to either the [Xₜ] or [X] vectors.

[Tₜₐₚₚ][Xₜ]=[Yₜ]+[Aₚₜ][Sₚ]+[A_{qt}][S_{q}]

Solving this equation for the transformed solution vector [Xₜ] gives the following expression.

[Xₜ]=[X_{yt}]+[Xₚₜ][Sₚ]+[X_{qt}][S_{q}]

The [Sₚ] and [S_{q}] vectors are defined by the following equations.

[B_{qt}][Xₜ]=[S_{q}]

[Bₚₜ][Xₜ]=[Sₚ]

The following equations are solved simultaneously. FIG. 2(b). These equations can also be reverse transformed by a second transformer 240 and solved by the system solver 230. FIG. 2(a).

([I]−[B_{qt}][X_{qt}])[S_{q}]=[B_{qt}][X_{yt}]+[B_{qt}][Xₚₜ][Sₚ]

([I]−[Bₚₜ][Xₚₜ])[Sₚ]=[Bₚₜ][X_{yt}]+[Bₚₜ][X_{qt}][S_{q}]

If the [S_{q}] vector is zero, the [Sₚ] vector can be determined by taking the reverse transform of the transformed expression for the transformed vector [Xₜ]. The reverse transform is calculated by the second transformer 240 using the following matrix products. The system solver 230 also restores the order of the elements in the transformed matrices and vectors to their original position before they are reverse transformed by the second transformer 240. The resulting equation is solved by the system solver 230.

[Xₑ]=[L₂][iFFT][Xₜ]

[Xₑ]=[L₂][iFFT]([X_{yt}]+[Xₚₜ][Sₚ]+[X_{qt}][S_{q}])

[Xₑ]=[X_{y}]+[Xₚ][Sₚ]+[X_{q}][S_{q}]

Since the [Xₑ] vector has zero pad portions, a system of equations can be formed from the pad rows of this equation.

[0]=[X_{y}]+[Xₚ][Sₚ]

The above disclosed methods can also be used to solve a system of equations where the coefficient matrix [T₀] is approximately Toeplitz. In this case, the Toeplitz matrix [T] is determined from the coefficient matrix [T₀] by statistically approximating the elements in the diagonals of the coefficient matrix [T₀] with those in the diagonals of the matrix [T].

An expander 250 can calculate the solution to the original system of equations with the [T₀] coefficient matrix from the solution to the system of equations with an approximate matrix, [Tₐ]. A difference matrix [d] is the [T₀] matrix minus the [Tₐ] matrix. The [Tₐ] matrix is a submatrix of the [Tₐₚₚ] matrix that has been separated into the product of narrowly banded upper and lower matrices. The matrix [A] comprises matrices [Aₚ] and [A_{q}]. The vector [S] comprises vectors [Sₚ] and [S_{q}].

[T₀][X₀]=[Y]

[Tₐₚₚ][Xₑ]=[Yₑ]+[A][S]

[Tₐ][Xₐ]=[Y]

The expander 250 calculates the vector [X₀] as follows.

[X₀]=([I]+[invTₐ][d]++)[Xₐ]

The expander 250 can also obtain an update by taking the initial solution to the system of equations with the [Tₐₚₚ] coefficient matrix and using it as the solution to the original equation.

[T₀][X₀]=[Y]

[Tₐₚₚ][Xₑ]=[Yₑ]+[A][S₁]

[T₀][Xₑ]=[Y₁]

The difference between the vector [Y] and the product of the original [T₀] matrix and the [Xₑ] solution is used as the new input vector for the matrix equation with the [Tₐₚₚ] coefficient matrix.

[Tₐₚₚ][X₁]=[Yₑ]−[Yₑ]+[A][S₂]

The vector [X₁] is an iterative refinement to the vector [X₁]. This process can be repeated until a desired result is obtained. The updates require few mathematical operations since backward and forward substitution has been performed on the [Aₜ] matrix and the result stored in memory. The only new quantities that need to be calculated are those resulting from backward and forward substitution on the transformed new vector [Yₑ−Y₁] and the new values in the vector [Sₙ].

The expander 250 can also use the solution to the system of equations represented by the [Tₐₚₚ] coefficient matrix as an initial solution vector estimate for other iteration techniques. Many such iteration techniques are known in the prior art including methods from the conjugate gradient method family of iterative methods.

If the coefficient matrix [T₀] is Toeplitz, and the solution to the system of equations with the coefficient matrix [Tₐₚₚ] is an insufficient approximation to the solution to the system of equations with the [T₀] coefficient matrix, the expander 250 can be used to calculate an improved solution to the system of equations with the coefficient matrix [T₀].

The above disclosed methods can be applied to a system of equations with a block coefficient matrix, [T_{b}]. The sub matrices [Tₛ] are Toeplitz and each can be separated into [C], [U] and [L] matrices. Pad and modified rows and columns may also be used in each sub matrix.

[T_{b}][X]=[Y]

The dimensions of the submatrices [Tₛ] are nₛ×nₛ. The dimensions of the block matrix [T_{b}] are n×n and there is no limit to the number of possible submatrices.

$$[ {T}_{b} ] = \vert \begin{matrix}{T}_{0} & {T}_{1} & {T}_{2} \\ {T}_{3} & {T}_{4} & {T}_{5} \\ {T}_{6} & {T}_{7} & {T}_{8}\end{matrix} \vert$$

The coefficient matrix can be factored into the sum of two terms. The sub matrices [Cₙ] and [D] are of dimensions nₛ×nₛ.

$$[ {T}_{b} ] = [ {C}_{s} ] + [ {D}_{1 b} ] [ {C}_{a} ] [ {D}_{2 b} ] \\ [ {D}_{1 b} ] [ {C}_{a} ] [ {D}_{2 b} ] = \vert \begin{matrix}[ {D}_{1} ] & & \\ & [ {D}_{1} ] & \\ & & [ {D}_{1} ]\end{matrix} \vert \vert \begin{matrix}{C}_{0} & {C}_{1} & {C}_{2} \\ {C}_{3} & {C}_{3} & {C}_{5} \\ {C}_{6} & {C}_{7} & {C}_{8}\end{matrix} \vert \vert \begin{matrix}[ {D}_{2} ] & & \\ & [ {D}_{2} ] & \\ & & [ {D}_{2} ]\end{matrix} \vert$$

The matrix separator 215 uses these equations to determine the elements in the matrices [C]. The [D] matrices are diagonal matrices. A quotient [U]/[L] can be substituted for each [D] matrix. A block transform matrix [F] with nonzero blocks only on the principal block diagonal is used to transform the coefficient matrix to a block banded form with a small bandwidth. The first transformer 220 performs the calculations required to transform the coefficient matrix and vector [Y]. The system solver 230 rearranges the rows and columns of the transformed coefficient matrix into a single banded coefficient matrix and solves the system of equations. The system altering device 210 inserts pad and modified rows and columns into the system of equations.

A system of equations with a block Toeplitz coefficient matrix [T] of the following form can be efficiently solved by duplicating the system of equations and multiplying the duplicated portion by a diagonal matrix with elements that all have values of negative one.

$$\vert \begin{matrix}{T}_{a} & {T}_{b} & {T}_{b} \\ - {T}_{b} & {T}_{a} & {T}_{b} \\ - {T}_{b} & - {T}_{b} & {T}_{a}\end{matrix} \vert \vert \begin{matrix}{x}_{1} \\ {x}_{2} \\ {x}_{3}\end{matrix} \vert = \vert \begin{matrix}{y}_{1} \\ {y}_{2} \\ {y}_{3}\end{matrix} \vert$$

The result is a circulant block matrix. A block FFT of this equation results in a matrix with nonzero blocks only on every other block on the principal block diagonal. The non-zero blocks on the principal block diagonal are Toeplitz.

$$\vert \begin{matrix}{T}_{a} & {T}_{b} & {T}_{b} & - {T}_{a} & - {T}_{b} & - {T}_{b} \\ - {T}_{b} & {T}_{a} & {T}_{b} & {T}_{b} & - {T}_{a} & - {T}_{b} \\ - {T}_{b} & - {T}_{b} & {T}_{a} & {T}_{b} & {T}_{b} & - {T}_{a} \\ - {T}_{a} & - {T}_{b} & - {T}_{b} & {T}_{a} & {T}_{b} & {T}_{b} \\ {T}_{b} & - {T}_{a} & - {T}_{b} & - {T}_{b} & {T}_{a} & {T}_{b} \\ {T}_{b} & {T}_{b} & - {T}_{a} & - {T}_{b} & - {T}_{b} & {T}_{a}\end{matrix} \vert \vert \begin{matrix}{x}_{1} \\ {x}_{2} \\ {x}_{3} \\ - {x}_{1} \\ - {x}_{2} \\ - {x}_{3}\end{matrix} \vert = \vert \begin{matrix}{x}_{1} \\ {y}_{2} \\ {y}_{3} \\ - {y}_{1} \\ - {y}_{2} \\ - {y}_{3}\end{matrix} \vert$$

The block Fourier transformed system of equations is in the form of three independent systems of equations, each with a coefficient matrix solvable by the above disclosed algorithms.

A block Fourier transform of dimension n_{b} has sub-matrices of dimension nₛ that are diagonal matrices with the elements in each sub-matrix having the same value. The values in the sub-matrices are the values in a Fourier transform of dimension n_{b}/nₛ.

The disclosed methods can be efficiently implemented using standard software languages. The methods can be executed on any hardware platform comprising digital circuits. Storage can be any suitable data carrier known in the art. The disclosed methods are very efficient when implemented on device components that comprise parallel processing architectures.

Other terms with the same or similar meaning to terms used in this disclosure can be used in place of those terms used in this disclosure. The form of any of the disclosed matrices can be changed so long as the new form does not significantly effect the accuracy or efficiency of the methods. Examples of such new forms include, but are not limited to, the [U] and [L] matrices being diagonally dominant matrices, the [D] and [Cₜ] matrices being matrices with nonzero elements only on a small number of nonprincipal diagonals, the matrices [Lₜ] and [Uₜ] being band dominant matrices, and any of the disclosed matrices having rows and columns with some or all elements being non-zero elements.

For the purposes of this disclosure, a band dominant matrix is a matrix where the sum of elements in the rows of selected bands of the matrix are greater than the sum of elements in those rows that are outside of the selected bands. The sum of multiple matrices and the product of multiple matrices can be represented as a single matrix. A single matrix can be represented as a sum or product of multiple matrices.

Both circulant matrices [Cₛ] and [Cₐ] can be factored into products of a diagonal matrix [D₁ₘ], a circulant matrix [Cₘ], and another diagonal matrix [D₂ₘ]. The diagonal matrices [D₁ₘ] and [D₂ₘ] and the circulant matrices [Cₘ] are different for each of the circulant matrices [Cₛ] and [Cₐ]. This factorization can result in the matrix [T] being expressed as a sum of terms with each term being a product of two diagonal matrices [D] and a circulant matrix [C].

The number and arrangement of the disclosed components can be varied. The matrices [C] are not required to be circulant. The expansion functions for the diagonals of the [U] and [L] matrices are not limited to being sin and cos functions. The [C] matrices can be any matrices that are placed in a desirable form by the same transform that transforms the [U] and [L] matrices to a desirable form. This transform is not required to be any type of Fourier transform.

1. A method for implementation on a device for calculating an unknown solution vector X in a system of equations with a known coefficient matrix T and a known vector Y, said device comprising digital circuits, the method comprising:
calculating a plurality of matrices C from said known coefficient matrix T;
calculating a plurality of transformed matrices Cₜ from a matrix F and said plurality of matrices C;
calculating a transformed known vector Yₜ from a product comprising a matrix L₁, said matrix F, and said known vector Y;
calculating a matrix Tₜₐₚₚ from a sum of products comprising said matrix F, said matrix L₁, said plurality of transformed matrices Cₜ, a matrix L₂, and an inverse of said matrix F;
calculating a transformed unknown solution vector Xₜ from elements contained in said matrix Tₜₐₚₚ and from elements contained in said transformed known vector Yₜ; and
calculating said unknown solution vector X from a product comprising said matrix L₂, said inverse of said matrix F, and said transformed unknown solution vector Xₜ.

2. A method as recited in claim 1, wherein said matrices L₁ and L₂ are diagonal matrices.

3. A method as recited in claim 2, wherein a product of said matrix F, said matrix L₁, and said inverse of said matrix F is banded.

4. A method as recited in claim 1, further comprising modifying at least one row of said matrix Tₜₐₚₚ.

5. A method as recited in claim 4, further comprising zero padding said known vector Y.

6. A method as recited in claim 1, wherein said known coefficient matrix T is block Toeplitz.

7. A device comprising digital circuits for calculating an unknown solution vector X in a system of equations with a known coefficient matrix T and a known vector Y, said device comprising:
a matrix separator for calculating a plurality of transformed matrices Cₜ from said known coefficient matrix T and a plurality of diagonal matrices D;
a first transformer for calculating a transformed known vector Yₜ from said known vector Y, and for calculating a matrix Tₜₐₚₚ from said plurality of transformed matrices Cₜ;
a system solver for calculating a transformed unknown solution vector Xₜ from elements contained in said matrix Tₜₐₚₚ and from elements contained in said transformed known vector Yₜ; and
a second transformer for calculating said unknown solution vector X from said transformed unknown solution vector Xₜ.

8. A device as recited in claim 7, wherein said matrix separator further calculates a plurality of matrices C from said known coefficient matrix T.

9. A device as recited in claim 8, wherein elements on a principal diagonal of said plurality of diagonal matrices D are determined from a matrix II wherein elements on a principal diagonal of said matrix II have values of either one or negative one.

10. A device as recited in claim 7, wherein:
said plurality of diagonal matrices D are each approximated by a quotient of one of a plurality of diagonal matrices U divided by one of a plurality of diagonal matrices L;
a plurality of transformed matrices Uₜ are each calculated by a product comprising a transform matrix F and one of said plurality of matrices U; and
said matrix Tₜₐₚₚ is calculated by a sum of matrix products comprising said plurality of transformed matrices Cₜ, and said plurality of transformed matrices Uₜ.

11. A device as recited in claim 7, further comprising an expander for calculating an iterative refinement to said unknown solution vector X.

12. A device as recited in claim 8, wherein:
each of said plurality of diagonal matrices D are approximated by a quotient of one of a plurality of diagonal matrices U divided by one of a plurality of diagonal matrices L;
elements on a principal diagonal of each of said plurality of matrices U are approximated by a sum of terms comprising a first set of weight constants and a first set of expansion functions; and
elements on a principal diagonal of each of said plurality of matrices L are approximated by a sum of terms comprising a second set of weight constants and a second set of expansion functions.

13. A device as recited in claim 7, further comprising a system altering device for altering said known coefficient matrix T.

14. A device as recited in claim 8, wherein said system solver modifies said matrix Tₜₐₚₚ.

15. A device as recited in claim 7, further comprising means for calculating said known coefficient matrix T from sub-matrices in a block coefficient matrix.

16. A device as recited in claim 7, wherein said known coefficient matrix T is block Toeplitz.

17. A computer readable medium storing computer program instructions for calculating an unknown solution vector X in a system of equations with a known coefficient matrix T and a known vector Y, the computer program instructions defining the steps of:
increasing dimensions of said known coefficient matrix T;
inserting zeros in said known vector Y;
calculating a transformed known vector Yₜ from said known vector Y;
calculating a plurality of matrices C from said known coefficient matrix T;
calculating a plurality of transformed matrices Cₜ from said plurality of matrices C;
calculating a matrix Tₜₐₚₚ from said plurality of transformed matrices Cₜ;
calculating elements in a pad vector Sₚ;
calculating a transformed unknown solution vector Xₜ from elements contained in said matrix Tₜₐₚₚ, from elements contained in said transformed known vector Yₜ, and from elements contained in said pad vector Sₚ; and
calculating said unknown solution vector X from said transformed unknown solution vector Xₜ.

18. The computer readable medium of claim 17, wherein said computer program instructions further comprise computer program instructions defining the steps of:
calculating elements in a modified vector Sₘ; and
calculating a contribution to said transformed unknown solution vector Xₜ from said modified vector Sₘ.

19. The computer readable medium of claim 17, wherein said computer program instructions further comprise computer program instructions defining the steps of modifying said matrix Tₜₐₚₚ.
